(19) United States
(12) Patent Application Publication
(10) Pub. No.: US 2016/0169756 A1
(43) Pub. Date: Jun. 16, 2016

(54) PRESSURE DETECTION DEVICE FOR A BLOWGUN

(71) Applicants: Yun-Long Kuo, (US); JIN TAY INDUSTRIES CO., LTD., New Taipei (TW)

(72) Inventor: Yun-Long KUO, NEW TAIPEI (TW)

(73) Assignees: JIN TAY INDUSTRIES CO., LTD., NEW TAIPEI (TW); Yun-Long KUO, NEW TAIPEI (TW)

(21) Appl. No.: 14/569,677

(22) Filed: Dec. 13, 2014

(51) Int. Cl. G01L 9/00; G01L 19/08; G01L 27/00; F41B 1/00

(52) U.S. Cl. CPC G01L 9/00; F41B 1/00; G01L 19/08; G01L 27/005

(57) ABSTRACT

A pressure detection device for a blowgun has a housing and a pressure-sensing unit. The pressure-sensing unit has a pressure sensor integrated circuit (IC) aligned with a pressure-sensing opening of the housing to detect air pressure inside the blowgun and outputting a voltage signal corresponding to the detected air pressure, a micro-controller unit (MCU) converting the voltage signal into a detected datum, and performing calibration and calculation with the detected datum to generate a blow-off pressure value displayed on a display screen, and a power-saving control circuit activating power supply to the pressure sensor IC and the MCU and shutting down power supply thereto when users are done with blowgun shooting.

### BACKGROUND OF THE INVENTION

1. Field of the Invention

The present invention relates to a pressure detection device and, more particularly, to a pressure detection device mounted on a blowgun to detect an air pressure inside the blowgun when the blowgun is blown by a user.

2. Description of the Related Art

Instead of being a weapon, blowguns have been used more for sport or games during when the targets are no longer human or animals, but darts with scores thereon. As the blowguns are used in a distance to the targets, a high score in blowgun shooting usually depends on aiming skill and blow-off force.

Speaking of the blow-off force, users of blowguns can only adjust the blow-off force by mouth-blowing the blowguns in between a powerful way and a gentle way to generate different air pressure inside the blowguns. However, after numerous tries, users of conventional blowguns may finally find a desired blow-off force adequate for blowgun shooting. The process of finding a desired blow-off force pushing a tip inside a blowgun to a dart, which involves coordination of mouth and lung pertaining to human sensory perception that is hard to be memorized and recorded, may need to be repeated again when users that are out of practice for a while do the blowgun shooting again or when the dart is moved from an original place to somewhere else, and thus makes the users frustrated and reluctant to play again. As a result, a solution that accurately gets the hold of the blow-off force or the air pressure inside the blowguns when doing the blowgun shooting is required to tackle the issue of the unscientific process of finding a desired blow-off force for conventional blowguns.

### SUMMARY OF THE INVENTION

An objective of the present invention is to provide a pressure detection device for a blowgun capable of providing accurate indication of the blow-off force upon the blowgun shooting.

To achieve the foregoing objective, the pressure detection device for a blowgun has a housing and a pressure-sensing unit.

The housing is adapted to mount around a blowgun and has a cylindrical channel, a sensor compartment and a pressure-sensing opening.

The cylindrical channel is longitudinally formed through an upper portion of the housing.

The sensor compartment is formed inside a portion of the housing located under the cylindrical channel, and has a chamber defined therein.

The pressure-sensing opening is formed through a top wall of the sensor compartment and communicates with the chamber inside the sensor compartment.

The pressure-sensing unit is mounted in the chamber of the sensor compartment and has a pressure sensor integrated circuit (IC), a microcontroller unit (MCU), a display screen, a battery, a direct current (DC) voltage boost IC and a power saving control circuit.

The pressure sensor IC is mounted on the pressure-sensing unit and is aligned with the pressure-sensing opening of the housing to detect an air pressure flow input generated inside the blowgun and flowing through the pressure-sensing opening upon a blowgun shooting, and outputs a voltage signal corresponding to the detected air pressure flow input.

The MCU is mounted on the pressure-sensing unit, is connected to the pressure sensor IC, converts the voltage signal received from the pressure sensor IC into a detected datum through an analog-to-digital conversion, and is built in with a procedure for performing calibration and calculation with the detected datum to generate a blow-off pressure value.

The display screen is connected to the MCU and serves to display the blow-off pressure value received from the MCU.

The battery serves to provide DC power to the pressure sensor IC, the MCU and the display screen.

The DC voltage boost IC is connected to the pressure sensor IC, the MCU, the display screen and the battery to receive the DC power from the battery and to boost the DC power to supply an operating power to the pressure sensor IC and the MCU for operation.

The power-saving control circuit is connected to the MCU and the DC voltage boost IC. The pressure-sensing unit further has a switch connected to the MCU. When the switch is pressed for the first time, the power-saving control circuit activates the DC voltage boost IC to supply a boosted voltage to the pressure sensor IC and the MCU. After the MCU starts operating, the MCU controls the DC voltage boost IC in a state of continuously supplying the boosted voltage through the power-saving control circuit. When the switch is pressed for over several seconds, the MCU then instructs the power-saving control circuit to shut down the power supplied from the battery.

Given the foregoing pressure detection device, the pressure-sensing unit can measure an exact air pressure inside a blowgun upon each blowgun shooting for users to see and evaluate how to adjust the blow-off force in a next blowgun shooting. The air pressure values recorded in different blowgun shooting condition can be also stored as historical information to remind users in shooting under similar conditions. Accordingly, the pressure detection device enable the blowgun shooting to become easy, scientific and entertaining.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a blowgun kit in accordance with the present invention;

FIG. 2 is an enlarged cross-sectional side view of a pressure detection device of the blowgun kit in FIG. 1;

FIG. 3 is a functional block diagram of the pressure detection device in FIG. 1; and

FIG. 4 is a circuit diagram of the pressure detection device in FIG. 3.

### DETAILED DESCRIPTION OF THE INVENTION

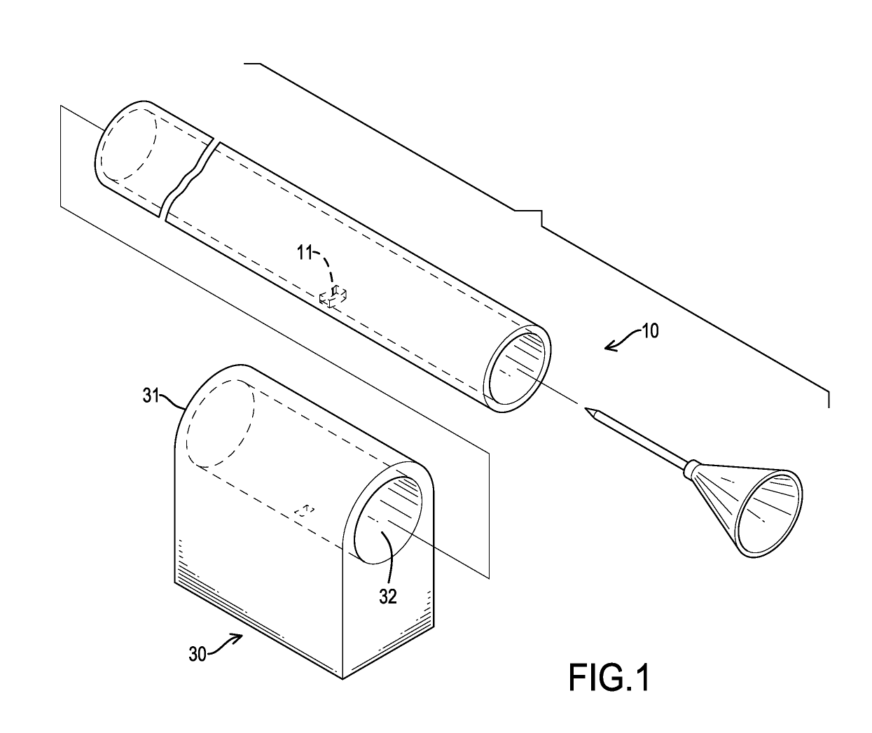

With reference to FIG. 1, a blowgun kit in accordance with the present invention is shown. In addition to a conventional portion, such as a blowgun 10 and a dart (not shown), the blowgun kit further has a pressure detection device 30 mounted around a tubular portion of the blowgun 10. The blowgun 10 resembles a conventional blowgun, but has an air aperture 11 formed through a lower wall portion of the tubular portion of the blowgun 10.

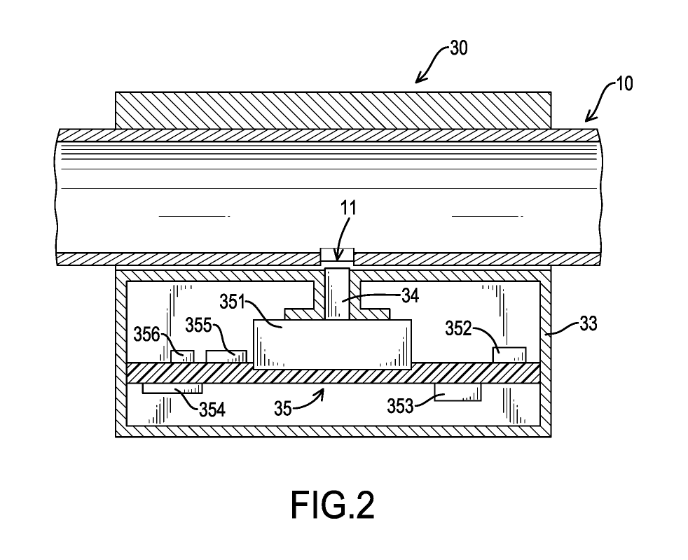

With reference to FIG. 2, the pressure detection device 30 has a housing 31 and a pressure-sensing unit 35. The housing 31 is mounted around the blowgun 10, and has a cylindrical channel 32, a sensor compartment 33, a pressure-sensing opening 34

The cylindrical channel 32 is longitudinally formed through an upper portion of the housing 31. The sensor compartment 33 is formed inside a portion of the housing 31 located under the cylindrical channel 32, and has a chamber 36 defined therein. The pressure-sensing opening 34 is formed through a top wall of the sensor compartment 33 and communicates with the chamber 36 inside the sensor compartment 33. The pressure-sensing unit 35 is mounted in the chamber 36 of the sensor compartment 33.

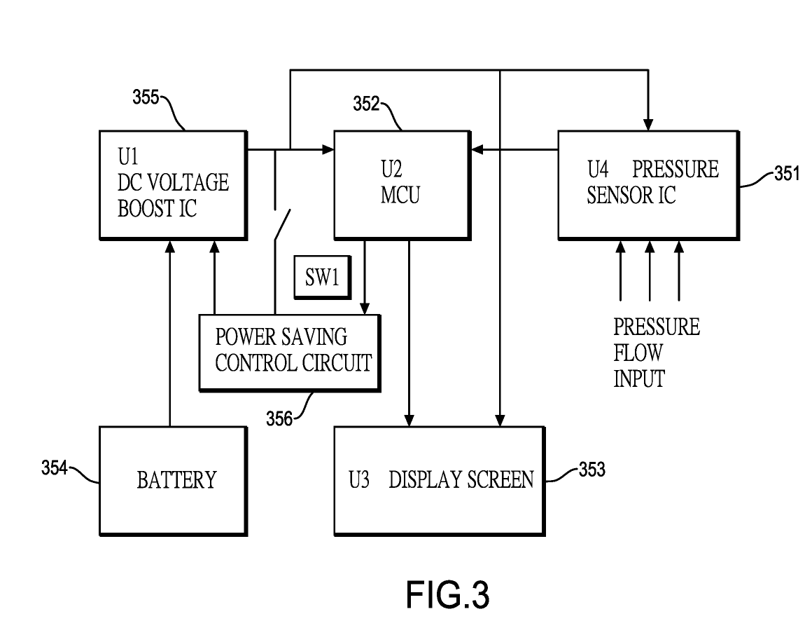

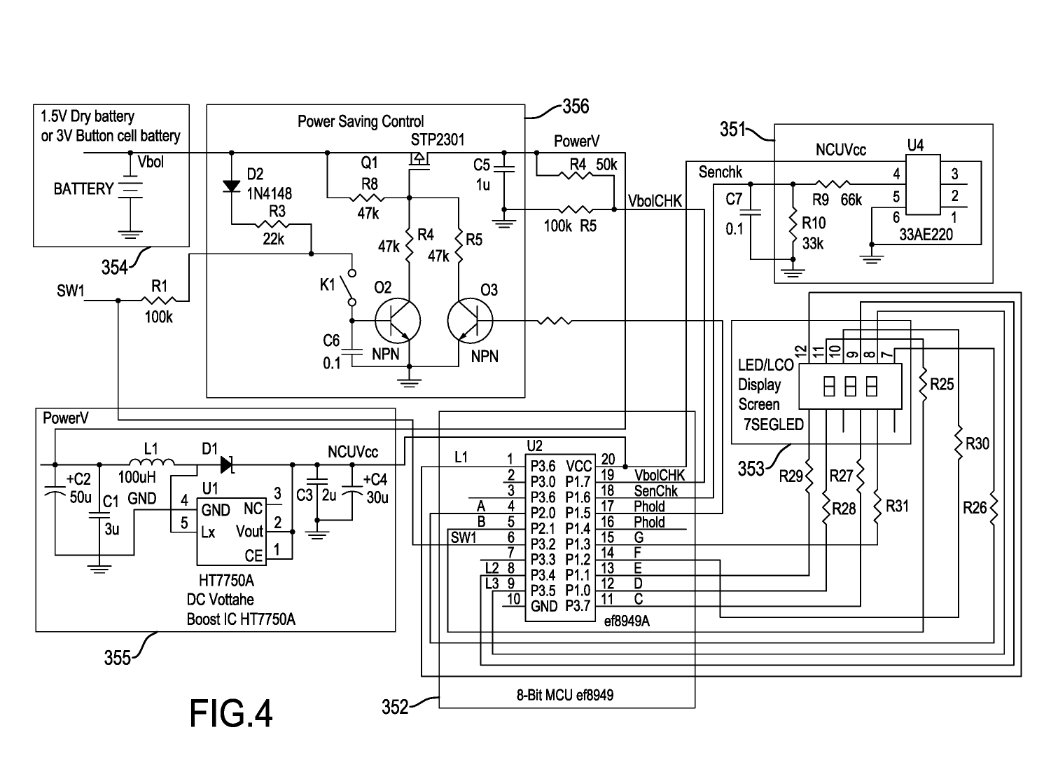

With reference to FIGS. 3 and 4, the pressure-sensing unit 35 takes the form of a circuit board, and has a pressure sensor IC (integrated circuit) 351, an MCU (Micro-controller Unit) 352, a display screen 353, a battery 354, a DC (Direct Current) voltage boost IC 355 and a power-saving control circuit 356.

The pressure sensor IC 351 is mounted on the pressure-sensing unit 35 and is aligned with and in contact with the pressure-sensing opening 34 to detect an air pressure flow input generated inside the blowgun 10 and flowing through the pressure-sensing opening 34 upon a blowgun shooting, and outputs a voltage signal corresponding to the detected air pressure flow input.

The MCU 352 is mounted on the pressure-sensing unit 35, is connected to the pressure sensor IC 351, converts the voltage signal received from the pressure sensor IC 351 into a detected datum through an analog-to-digital conversion, and is built in with a procedure for performing calibration and calculation with the detected datum to generate a blow-off pressure value. The MCU 352 further has a non-volatile memory, such as EEPROM (Electrically Erasable Programmable Read Only Memory) and the like, to store multiple blow-off pressure values detected and calculated at different time points as historical information for user's references.

The display screen 353 is connected to the MCU 352, may be an LED (Light-emitting diode) display screen or an LCD (Liquid Crystal Display) display screen, and serves to display the blow-off pressure value received from the MCU 352.

The battery 354 serves to provide DC power to the pressure sensor IC 351, the MCU 352 and the display screen 353, and may be a 1.5V dry battery or a 3V button cell battery.

The DC voltage boost IC 355 is connected to the pressure sensor IC 351, the MCU 352, the display screen 353 and the battery 354 to receive the DC power from the battery 354 and to boost the DC power to 5V as an operating power supplied to the pressure sensor IC 351 and the MCU 352 for operation.

The power-saving control circuit 356 is connected to the MCU 352 and the DC voltage boost IC 355. The pressure-sensing unit 35 further has a switch SW1 connected to the MCU 352. When the switch SW1 is pressed for the first time, the power-saving control circuit 356 activates the DC voltage boost IC 355 to supply 5V to the pressure sensor IC 351 and the MCU 352. After the MCU 352 starts operating, the MCU 352 controls the DC voltage boost IC 355 in a state of continuously supplying 5V through the power-saving control circuit 356. When the switch SW1 is pressed to last for over several seconds, the MCU 352 then instructs the power-saving control circuit 356 to shut down the power supplied from the battery 354 for the purpose of saving the power of the battery 354.

When the blowgun 10 is operated, the switch SW1 is pressed to start supplying the power required for operation of the MCU 352 and the pressure sensor IC 355. After the tip of the blowgun 10 is blown off, the pressure sensor IC 355 detects an air pressure inside the blowgun 10 and an air pressure value is displayed on the display screen 353. It is up to user's choice to store the air pressure value in the non-volatile memory of the MCU 352 for users to keep track of the air pressure values under different shooting conditions. When users are done with the blowgun shooting, the switch SW1 can be pressed for several seconds and the MCU 352 will instruct the power-saving control circuit 356 to shut down the power of the blowgun 10.

In sum, given the pressure detection device 30, users can be aware of the blow-off force generated by mouth blowing the blowgun in an exact manner, and thus know how to adjust the blow-off force in consideration of actual result of blowgun shooting, thereby making the blowgun shooting become easier and more entertaining.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A pressure detection device for a blowgun, comprising:
a housing adapted to mount around a blowgun and having:
a cylindrical channel longitudinally formed through an upper portion of the housing;
a sensor compartment formed inside a portion of the housing located under the cylindrical channel, and having a chamber defined therein; and
a pressure-sensing opening formed through a top wall of the sensor compartment and communicating with the chamber inside the sensor compartment; and
a pressure-sensing unit mounted in the chamber of the sensor compartment and having:
a pressure sensor integrated circuit (IC) mounted on the pressure-sensing unit and aligned with the pressure-sensing opening of the housing to detect an air pressure flow input generated inside the blowgun and flowing through the pressure-sensing opening upon a blowgun shooting, and outputting a voltage signal corresponding to the detected air pressure flow input;
a micro-controller unit (MCU) mounted on the pressure-sensing unit, connected to the pressure sensor IC, converting the voltage signal received from the pressure sensor IC into a detected datum through an analog-to-digital conversion, and built in with a procedure for performing calibration and calculation with the detected datum to generate a blow-off pressure value;
a display screen connected to the MCU and serving to display the blow-off pressure value received from the MCU;
a battery serving to provide DC power to the pressure sensor IC, the MCU and the display screen;
a direct current (DC) voltage boost IC connected to the pressure sensor IC, the MCU, the display screen and the battery to receive the DC power from the battery and to boost the DC power to supply an operating power to the pressure sensor IC and the MCU for operation; and
a power-saving control circuit connected to the MCU and the DC voltage boost IC, wherein the pressure-sensing unit further has a switch connected to the MCU, when the switch is pressed for the first time, the power-saving control circuit activates the DC voltage boost IC to supply a boosted voltage to the pressure sensor IC and the MCU, after the MCU starts operating, the MCU controls the DC voltage boost IC in a state of continuously supplying the boosted voltage through the power-saving control circuit, and when the switch is pressed for over several seconds, the MCU then instructs the power-saving control circuit to shut down the power supplied from the battery.

2. The pressure detection device as claimed in claim 1, wherein the MCU has a non-volatile memory to store multiple blow-off pressure values detected and calculated at different time points as historical information for user's references.

3. The pressure detection device as claimed in claim 2, wherein the non-volatile memory of the MCU is electronically erasable programmable read only memory (EEPROM).

4. The pressure detection device as claimed in claim 1, wherein the display screen is a light-emitting diode (LED) display screen or a liquid crystal display (LCD) display screen.

5. The pressure detection device as claimed in claim 2, wherein the display screen is an LED display screen or an LCD display screen.

6. The pressure detection device as claimed in claim 3, wherein the display screen is an LED display screen or an LCD display screen.

7. The pressure detection device as claimed in claim 1, wherein the battery is a 1.5V dry battery or a 3V button cell battery.

8. The pressure detection device as claimed in claim 2, wherein the battery is a 1.5V dry battery or a 3V button cell battery.

9. The pressure detection device as claimed in claim 3, wherein the battery is a 1.5V dry battery or a 3V button cell battery.

10. The pressure detection device as claimed in claim 4, wherein the battery is a 1.5V dry battery or a 3V button cell battery.

11. The pressure detection device as claimed in claim 5, wherein the battery is a 1.5V dry battery or a 3V button cell battery.

12. The pressure detection device as claimed in claim 6, wherein the battery is a 1.5V dry battery or a 3V button cell battery.
